(19) United States
(12) Patent Application Publication
(10) Pub. No.: US 2010/0208337 A1
(43) Pub. Date: Aug. 19, 2010

(54) NEAR-INFRARED ABSORBING FILM AND OPTICAL FILTER FOR PLASMA DISPLAY PANEL USING THE SAME

(75) Inventors: Atsuyuki Uehara, Tokyo (JP); Junichi Segawa, Tokyo (JP); Kenji Akuta, Tokyo (JP); Masaki Fujimoto, Tokyo (JP)

Correspondence Address: Nields, Lemack & Frame, LLC, 176 E. Main Street, Suite #5, Westborough, MA, 01581, US

(73) Assignee: Nippon Kayaku Kabushiki Kaisha, Chiyoda-ku, Tokyo (JP)

(21) Appl. No.: 12/452,091

(22) PCT Filed: Jun. 9, 2008
(86) PCT No.: PCT/JP2008/060529

§ 371 Date: Mar. 10, 2010

(30) Foreign Application Priority Data
Jun. 27, 2007 (JP) 2007-168668

(51) Int. Cl. G02B 5/22; B32B 27/30

(52) U.S. Cl. 359/359; 428/522

(57) ABSTRACT

A near-infrared absorbing film which is excellent in heat resistance and moist-heat resistance and retains optical properties including satisfactory near-infrared absorbing ability. The near-infrared absorbing film comprises a transparent base and a pressure-sensitive adhesive layer formed on one side of the base from a pressure-sensitive adhesive comprising a near-infrared absorbing dye and a copolymer of a constituent monomer which is a (C5-C10) cycloalkyl ester of (meth)acrylic acid. This near-infrared absorbing film may be laminated to other functional film(s) to give a laminate useful as an optical filter for PDPs.

### TECHNICAL FIELD

The present invention relates to an optical film provided with a tacky layer having a near-infrared absorbing ability, on a transparent base, and uses thereof. More particularly, the present invention relates to a near-infrared absorbing film provided with a tacky layer formed by applying a tackifying agent containing a near-infrared absorbing dye and a specific copolymer on a transparent base, and an optical filter for plasma display panels using the near-infrared absorbing film.

### BACKGROUND ART

The principle of the plasma display panel (hereinafter, described as PDP) is such that voltage is applied to a noble gas (neon or xenon) encapsulated in a cell interposed between two sheets of glass substrates, so that the noble gas is brought to the plasma state, and the ultraviolet radiation emitted by the noble gas excites a fluorescent substance applied on the cell wall surfaces, thereby generating visible light that is needed in the formation of images. However, the PDP also emits, together with the visible light, electromagnetic waves that are harmful to human bodies, near-infrared radiation having a wavelength of 800 nm to 1100 nm that causes malfunction in electric appliances, orange light rays having a wavelength of near 595 nm (hereinafter, described as neon light), which lower the color purity of red light, and the like. Thus, there is a need for an optical filter that shields (cuts) these harmful electromagnetic waves other than the visible light needed in the formation of images.

Even among the harmful electromagnetic waves mentioned above, the near-infrared radiation in particular has a risk of causing malfunction in remote controllers for electric appliances which utilize near-infrared rays, or in communication instruments that utilize near-infrared rays, such as personal computers or cordless telephones. Therefore, it is considered indispensable to install an optical filter having a function of blocking the near-infrared rays, at the front of PDP's.

There has been suggested a method of using an optical filter having a near-infrared absorbing film as a constituent element, as a filter blocking the near-infrared rays. This near-infrared absorbing film is produced by, for example, coating a binder resin such as, for example, a polyester-based resin, a polymethyl methacrylate-based resin, a polycarbonate-based resin or a polystyrene-based resin, which contains a near-infrared absorbing dye, on a transparent film made of polyethylene terephthalate (PET) or the like. The near-infrared absorbing dye that is used herein has the maximum absorption wavelength at 800 to 1100 nm. For example, a diimmonium-based dye, a cyanine-based dye, an indocyanine-based dye, a polymethine-based dye, a squarylium-based dye, a phthalocyanine-based dye, a dithiol complex-based dye, an azo-based dye and the like are widely used. Among these, a diimmonium-based dye that has a relatively broad absorption wavelength range in the near-infrared region is preferably used either individually, or in combination with other near-infrared absorbing dye while the diimmonium-based dye is used as a base.

However, in the method of bonding a film having a near-infrared absorbing ability to a transparent substrate made of glass or the like, with a separately provided tacky layer interposed between the film and the substrate, additional production steps are needed, and the production efficiency is decreased. Thus, incorporation of a near-infrared absorbing dye into the tacky layer itself is attempted. Thereby, the process for optical filter production is shortened, and at the same time, the near-infrared absorbing ability can be imparted between any layers that constitute an optical filter, so that it can be expected to enhance the efficiency of the optical filter production. For example, Patent Document 1 describes a near-infrared absorbing film having a near-infrared absorbing dye incorporated into an acrylic resin tackifying agent.

However, when a near-infrared absorbing dye such as a diimmonium-based dye is incorporated into the tacky layer, there occurs a problem that heat resistance stability or moist-heat resistance stability becomes poor. Thus, various investigations are conducted to stabilize the near-infrared absorbing dye that is unstable in the tacky layer. For example, Patent Document 2 suggests using a silicone-based tackifying agent as the tackifying agent, but silicone-based tackifying agents pose a difficulty such that handling, and particularly the formation of a tacky layer, is troublesome. Patent Document 3 suggests an optical filter having a structure comprising a transparent base laminated with a near-infrared absorbing layer containing a near-infrared absorbing dye in an acrylic resin containing an alicyclic group and a hydroxyl group value of 10 or less. However, this optical filter is different from those optical filters having a near-infrared absorbing dye incorporated in the tacky layer.

### [Patent Document 1] Japanese Patent No. 3621322

### [Patent Document 2] JP-A No. 2005-62506

### [Patent Document 3] JP-A No. 2005-84476

### DISCLOSURE OF THE INVENTION

### Problems to be Solved by the Invention

It is an object of the present invention to produce a near-infrared absorbing film in which a layer provided by coating a tackifying agent (hereinafter, refined to as a tacky layer) contains a near-infrared absorbing dye, and which is excellent in heat resistance or moist-heat resistance, and maintains satisfactory optical properties, and to provide an optical filter for PDP's using this film.

### Means for Solving the Problems

The inventors of the present invention have devotedly conducted investigations to solve the problems described above, and as a result, they found that the problems can be solved by using a tackifying agent containing a copolymer of a specific (meth)acrylic acid alkyl ester as the tackifying agent used upon forming a tacky layer containing a near-infrared absorbing dye. Thus, the inventors completed the present invention.

Specifically, the present invention relates to the following:

(1) A near-infrared absorbing film comprising a transparent base, and provided on one side of the base, a tacky layer formed from a tackifying agent containing a near-infrared absorbing dye and a copolymer having a (C5-C10) cycloalkyl ester of (meth)acrylic acid as a constituent monomer;

(2) The near-infrared absorbing film according to (1) above, wherein the copolymer is a copolymer having a (C5-C10) cycloalkyl ester of (meth)acrylic acid, a (C3-C10) alkyl ester of (meth)acrylic acid, and an unsaturated polybasic acid or a (meth)acrylic acid-based monomer having a functional group, as constituent monomers;

(3) The near-infrared absorbing film according to (1) or (2) above, wherein the (C5-C10) cycloalkyl ester of (meth)acrylic acid is at least one compound selected from the group consisting of cyclopentyl acrylate, cyclohexyl acrylate, methyl-substituted cyclohexyl acrylate, t-butyl-substituted cyclohexyl acrylate, isobornyl acrylate, and decahydro-2-naphthyl acrylate;

(4) The near-infrared absorbing film according to any one of (1) to (3) above, wherein the near-infrared absorbing dye is a diimmonium-based dye represented by the following formula (1):

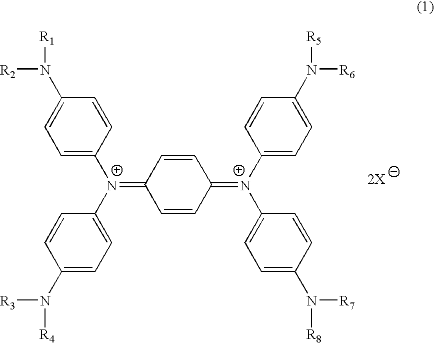

wherein R₁ to R₈ each independently represent a hydrogen atom or an aliphatic hydrocarbon residue which may have a substituent, and X represents a monovalent anion;

(5) The near-infrared absorbing film according to any one of (1) to (4) above, wherein the tackifying agent forming the tacky layer contains a crosslinking agent; and

(6) An optical filter for plasma display panels, comprising the near-infrared absorbing film according to any one of (1) to (5) above, and a film having an electromagnetic wave shielding function and/or a film having a reflection reducing function, as constituent elements.

### EFFECTS OF THE INVENTION

The near-infrared absorbing film of the present invention has satisfactory near-infrared absorbing performance or optical properties, and is excellent in heat resistance or stability. Furthermore, the near-infrared absorbing film has a tackifying agent layer so that the film can be conveniently laminated with other functional films, and thus production of optical filters for PDP's and the like is also made easy.

### BEST MODE FOR CARRYING OUT THE INVENTION

Hereinafter, the present invention will be described in detail.

The near-infrared absorbing film of the present invention is a near-infrared absorbing film formed by providing a tacky layer of an acrylic resin on one side of a transparent base, characterized in that the tackifying agent forming the tacky layer contains, as a main component, an acrylic acid-based copolymer having a (C5-C10) cycloalkyl ester of (meth)acrylic acid as a monomer component, and the tacky layer contains a near-infrared absorbing dye such as the diimmonium-based dye represented by the formula (1).

In the present specification, the “(meth)acrylic acid” means acrylic acid or methacrylic acid. Furthermore, a group affixed with the expression “(Cm-Cn)” (provided that m and n are positive integers) means that the group has a number of carbon atoms in the range of m to n.

The tackifying agent used in the present invention contains, as a main constituent component, a copolymer having a (C5-C10) cycloalkyl ester of (meth)acrylic acid as a constituent monomer. In a preferred embodiment, the copolymer is a copolymer having a (C5-C10) cycloalkyl ester of (meth)acrylic acid and a (C3-C10) alkyl ester of (meth)acrylic acid as constituent monomers. In a more preferred embodiment, the copolymer is a copolymer having a (C5-C10) cycloalkyl ester of (meth)acrylic acid, a (C3-C10) alkyl ester of (meth)acrylic acid, and an unsaturated polybasic acid or a (meth)acrylic acid-based monomer having a functional group, as constituent monomers.

Specific examples of the (C5-C10) cycloalkyl ester of (meth)acrylic acid include cyclopentyl acrylate, cyclopentyl methacrylate, cyclohexyl acrylate, cyclohexyl methacrylate, 2-, 3- or 4-methylcyclohexyl acrylate, 2-, 3- or 4-methylcyclohexyl methacrylate, 3- or 4-t-butylcyclohexyl acrylate, 3- or 4-t-butylcyclohexyl methacrylate, 1,2,3,4-tetrahydro-2-naphthyl acrylate, 1,2,3,4-tetrahydro-2-naphthyl methacrylate, decahydro-2-naphthyl acrylate, decahydro-2-naphthyl methacrylate, isobornyl acrylate, dicyclopentyl acrylate, dicyclopentyl methacrylate, and the like. Among these, it is preferable to select one or more selected from cyclopentyl acrylate, cyclohexyl acrylate, methyl-substituted cyclohexyl acrylate, t-butyl-substituted cyclohexyl acrylate, isobornyl acrylate, and decahydro-2-naphthyl acrylate. In an even more preferred embodiment, the compound is selected from cyclohexyl acrylate, methyl-substituted cyclohexyl acrylate, or t-butyl-substituted cyclohexyl acrylate.

Specific examples of the (C3-C10) alkyl ester of (meth)acrylic acid include n-propyl, i-propyl, n-butyl, i-butyl, sec-butyl, t-butyl, n-pentyl, i-pentyl, n-hexyl, 2-ethylbutyl, 2-ethylhexyl, n-octyl, n-decyl and benzyl esters of (meth)acrylic acid. Among these, n-butyl, i-butyl, sec-butyl, t-butyl, n-pentyl, i-pentyl, n-hexyl, 2-ethylbutyl and 2-ethylhexyl esters of acrylic acid are preferred. These esters may be used in combination of two or more species as necessary.

The unsaturated polybasic acid or (meth)acrylic acid-based monomer having a functional group is utilized as a reaction point in the case of using a crosslinking agent, and through the crosslinking reaction, amelioration of tackiness, enhancement of the cohesive force or heat resistance due to the control of the glass transition temperature of the copolymer, and the like can be expected.

Specific examples of the unsaturated polybasic acid include monomers having two or more carboxyl groups, such as itaconic acid, maleic acid, crotonic acid and fumaric acid.

Specific examples of the (meth)acrylic acid-based monomer having a functional group include a monomer having a carboxyl group, such as acrylic acid or methacrylic acid; a monomer having a hydroxyl group, such as hydroxyethyl (meth)acrylate, hydroxypropyl (meth)acrylate, or hydroxybutyl (meth)acrylate; an amide-based monomer such as acrylamide, morpholylacrylamide, or N-methylol (meth)acrylamide; a monomer having a (substituted) amino group, such as N,N-dimethylaminoethyl (meth)acrylate; a monomer having an epoxy group, such as glycidyl (meth)acrylate; and the like.

The proportion of these monomers occupying in the total weight of the monomers constituting the copolymer is preferably 0.5 to 10% by weight, and more preferably 2 to 6% by weight.

In regard to the copolymer having the (C5-C10) cycloalkyl ester of (meth)acrylic acid and (C3-C10) alkyl ester of (meth)acrylic acid as the constituent monomers according to the present invention, the ratio of the (C5-C10) cycloalkyl ester of (meth)acrylic acid and the (C3-C10) alkyl ester of (meth)acrylic acid is one part of the former to 1 to 20 parts, and preferably 2 to 10 parts of the latter, as a weight ratio. When the amount of use of the (C3-C10) alkyl ester of (meth)acrylic acid per one part of the (C5-C10) cycloalkyl ester of (meth)acrylic acid is less than one part, the tack force tends to decrease. On the other hand, when the amount of use of the (C3-C10) alkyl ester of (meth)acrylic acid per one part of the (C5-C10) cycloalkyl ester of (meth)acrylic acid is more than 20 parts, the heat resistant stability or moist-heat resistant stability of the near-infrared absorbing dye contained in the tacky layer tends to decrease. In the case of adding an unsaturated polybasic acid or a (meth)acrylic acid-based monomer having a functional group to the copolymer as a constituent monomer other than the above two esters, the amount of use is such that, as described above, the proportion of the constituent monomer occupying in the total weight of the monomers constituting the copolymer is preferably 0.5 to 10% by weight, and more preferably 2 to 6% by weight.

In regard to the synthesis of the copolymer that constitutes a main component of the tackifying agent according to the present invention, polymerization methods that are known per se, such as solution polymerization, suspension polymerization and bulk polymerization, can be all applied.

In the case of performing polymerization, it is preferable to use a radical polymerization initiator. Specific examples of the radical polymerization initiator that may be used include benzoyl peroxide, lauroyl peroxide, di-t-butyl peroxide, t-butyl hydroperoxide, dicumyl peroxide, azobisisobutyronitile, azobiscyclohexanecarbonitrile, potassium persulfate, ammonium persulfate and the like. Thus, use can be made of all of those that can be used in conventional radical polymerization. The amount of use of the polymerization initiator is not particularly limited, but the amount of use is preferably in the range of 0.01 to 1.0% by weight relative to the total weight of the monomer components.

It is preferable that the polymerization temperature is in the range of 0 to 200° C., and particularly in the range of 50 to 100° C., from the viewpoints of the rate of polymerization, reaction control, molecular weight and the like. The polymerization time depends on the polymerization temperature, and is usually in the range of 1 to 48 hours; however, in a more preferred embodiment, the polymerization time is 3 to 12 hours. The copolymer that is used as the tackifying agent in the present invention preferably has a weight average molecular weight of 100,000 or more, and particularly preferably 1,000,000 to 2,000,000, from the viewpoint of heat resistance, tack properties or the like (hereinafter, the copolymer may be referred to as an acrylic acid-based copolymer).

As for the near-infrared absorbing dye that is used in the present invention, any dye having the maximum absorption wavelength at 800 to 1100 nm can be used without particular limitation. Examples of the near-infrared absorbing dye that may be used include a diimmonium-based dye, a nitroso compound and metal salts thereof; a cyanine-based dye, an indocyanine-based dye, a polymethine-based dye, a squarylium-based dye, a phthalocyanine-based dye, a naphthalocyanine-based dye, a triarylmethane-based dye, a thiol-nickel complex-based compound, a dithiol complex-based dye, a naphthoquinone-based dye, an anthraquinone-based dye, an azo-based dye, and the like.

Among these, a diimmonium-based dye having a relatively broad absorption wavelength range in the near-infrared region, is preferably used. A diimmonium-based dye that is particularly preferably used in the present invention is represented by the formula (1). R₁ to R₈ in the formula (1) each independently represent a hydrogen atom, or an aliphatic hydrocarbon residue which may have a substituent. Here, the aliphatic hydrocarbon residue means a group obtained by removing one hydrogen atom from a saturated or unsaturated, linear, branched or cyclic aliphatic hydrocarbon. The aliphatic hydrocarbon residue preferably has 1 to 12 carbon atoms, and more preferably has 3 to 8 carbon atoms from the viewpoints of solubility in organic solvents and thermal stability.

Specific examples of saturated, linear and branched aliphatic hydrocarbon residues include a methyl group, an ethyl group, an n-propyl group, an i-propyl group, an n-butyl group, an i-butyl group, a sec-butyl group, a t-butyl group, an n-pentyl group, an i-pentyl group, a t-pentyl group, an n-hexyl group, an i-hexyl group, an n-octyl group, an i-octyl group, a decyl group, a dodecyl group, and the like. Among these, preferred examples include an n-propyl group, an i-propyl group, an n-butyl group, an i-butyl group, a sec-butyl group, an n-pentyl group, and a neopentyl group.

The aliphatic hydrocarbon residue may have a substituent such as an aryl group such as a phenyl group, a benzyl group or a phenylethyl group; a halogen atom such as fluorine, chlorine or bromine; a hydroxyl group; an alkoxy group such as a methoxy group, an ethoxy group or a propoxy group; an alkoxyalkyl group such as a methoxyethyl group or an ethoxyethyl group; an aryloxy group; an acyloxy group such as an acetyloxy group, a butyryloxy group or a benzoyloxy group; an N,N-dialkylamino group; a cyano group; a sulfoalkyl group such as a sulfomethyl group; a carboxyl group; or an alkoxycarbonyl group such as a methoxycarbonyl group.

Specific preferred examples of the aliphatic hydrocarbon residue having a substituent include a cyano-substituted alkyl group such as a cyanomethyl group, a 2-cyanoethyl group, a 2- or 3-cyanopropyl group, a 2-, 3- or 4-cyanobutyl group, or a 2-, 3-, 4- or 5-cyanopentyl group; an alkoxy-substituted alkyl group such as a methoxyethyl group, an ethoxyethyl group, a 3-methoxypropyl group, a 3-ethoxypropyl group, a 4-methoxybutyl group, a 4-ethoxybutyl group, a 5-methoxypentyl group, or a 5-ethoxypentyl group; and a fluoro-substituted alkyl group such as a monofluoromethyl group, a trifluoromethyl group, a trifluoroethyl group, a tetrafluoroethyl group, a pentafluoroethyl group, a heptafluoropropyl group, a perfluorobutyl group, a perfluoropentyl group, a perfluorohexyl group or a perfluorooctyl group.

Specific examples of unsaturated, linear and branched aliphatic hydrocarbon residues include a vinyl group, an allyl group, a propenyl group, an isopropenyl group, a butenyl group, a pentenyl group, a hexenyl group, an isohexenyl group, an octenyl group and the like, and these may also have a substituent such as a halogen atom, a hydroxyl group, an alkoxy group or a carboxy group.

Specific examples of cyclic aliphatic hydrocarbon residues include a cyclopentyl group, a cyclohexyl group, and a cyclohexenyl group, and these may also have a substituent such as mentioned above.

These groups may exist each independently, and for example, the respective combinations of R₁ with R₂, R₃ with R₄, R₅ with R₆, and R₇ with R₈ in the compound represented by the formula (1) may be combinations of different groups. Furthermore, for example, one amino group substituted with an unsubstituted linear alkyl group and an unsubstituted branched alkyl group; one amino group substituted with an unsubstituted linear alkyl group and a cyano-substituted alkyl group; or the like may also be used. It is preferable that at least one among R₁ to R₈ is a branched alkyl group, and it is more preferable that R₁ to R₈ are all alkyl groups being branched at terminals. In regard to that R₁ to R₈ are all alkyl groups being branched at terminals, an i-propyl group, an i-butyl group, an i-pentyl group, an i-hexyl group or the like may be mentioned, and it is particularly preferable that R₁ to R₈ are all i-butyl groups.

The anion X in the formula (1) is a monovalent anion, and examples thereof include an inorganic anion, an anion of an organic acid, an organometallic anion, and the like.

Specific examples of the inorganic anion include, for example, a halogen ion such as a fluorine ion, a chlorine ion, a bromine ion or an iodine ion; a thiocyanate ion, a hexafluoroantimonate ion, a perchlorate ion, a periodate ion, a nitrate ion, a tetrafluoroborate ion, a hexafluorophosphate ion, a molybdate ion, a tungstate ion, a titanate ion, a vanadate ion, a phosphate ion, a borate ion, a tetrafluorotantalate ion, a tetrafluoroniobate ion, and the like. Anions of strong acids are preferred, and preferred examples include a perchlorate ion, a tetrafluoroborate ion, a hexafluorophosphate ion, and a hexafluoroantimonate ion.

Specific examples of the anion of an organic acid and the organometallic anion include, for example, an organic carboxylate ion such as an acetate ion, a lactate ion, a trifluoroacetate ion, a propionate ion, a benzoate ion, an oxalate ion, a succinate ion, or a stearate ion; an organic sulfonate ion such as a methanesulfonate ion, a toluenesulfonate ion, a naphthalene monosulfonate ion, chlorobenzenesulfonate ion, a nitrobenzenesulfonate ion, a dodecylbenzenesulfonate ion, a benzenesulfonate ion, an ethanesulfonate ion, or a trifluoromethanesulfonate ion; an organoborate ion such as a tetraphenylborate ion, or a butyltriphenylborate ion; and a fluorine-containing organic acid ion such as a bis(trifluoromethanesulfonyl)imidate ion, or a tris(trifluoromethanesulfonyl)methidate ion. Preferred examples include a bis(trifluoromethanesulfonyl)imidate ion, or a tris(trifluorometanesulfonyl)methidate ion, which are anions of strong acids.

Among these anions, a bis(trifluoromethanesulfonyl)imidate ion, or a tris(trifluorometanesulfonyl)methidate ion is particularly preferred.

The diimmonium-based dye that is used in the present invention may be used alone, but for the purpose of extending the desired absorption wavelength range of near-infrared rays, adjusting the proportion of absorption, or the like, the diimmonium-based dye may also be used in combination with one or more species of other near-infrared absorbing compounds. Examples of the other near-infrared absorbing compounds include diimmonium-based dyes other than the diimmonium-based dye represented by the formula (1), a nitroso compound and metal salts thereof a cyanine-based dye, a squarylium-based dye, a thiol-nickel complex-based compound, a phthalocyanine-based dye, a naphthalocyanine-based dye, a triarylmethane-based dye, a naphthoquinone-based dye, an anthraquinone-based dye, and the like.

In the case of using a dye other than a diimmonium-based dye, the proportion of the diimmonium-based dye in the total amount of the near-infrared absorbing dyes is preferably 50% by weight or more.

When a crosslinking agent is incorporated into the tackifying agent, the acrylic acid-based copolymer can be subjected to a crosslinking treatment. Specific examples of the crosslinking agent that may be used include, for example, a polyisocyanate such as an aliphatic diisocyanate such as hexamethylene diisocyanate or a trimethylolpropane adduct of hexamethylene diisocyanate, or an aromatic diisocyanate such as tolylene diisocyanate, xylene diisocyanate or a trimethylolpropane adduct of tolylene diisocyanate; a melamine compound such as trimethylolmelamine; a polyamine such as hexamethylenediamine or triethylamine; an epoxy compound such as polyethylene glycol diglycidyl ether or trimethylolpropane triglycidyl ether; a metal chelate compound such as aluminum acetylacetone; a metal salt such as aluminum chloride; and the like. These may be used as mixtures of two or more species.

The amount of incorporation of the crosslinking agent is usually 0.005 to 5 parts by weight, and preferably 0.01 to 3 parts by weight, relative to 100 parts by weight of the acrylic acid-based copolymer.

For the tackifying agent according to the present invention, in addition to the components described above, a polyester-based resin, a polyamide-based resin, a polyurethane-based resin, a polyolefin-based resin, a polycarbonate-based resin, a natural or synthetic rubber-based resin, a silicone-based resin or the like can be appropriately selected and incorporated, as necessary.

Furthermore, in order to enhance the durability of the tacky layer containing a near-infrared absorbing dye, an antioxidant, an ultraviolet absorbent or the like can be added. As for the antioxidant, phenol-based, amine-based, hindered phenol-based, hindered amine-based, sulfur-based, phosphate-based, phosphite-based or metal complex-based agents may be mentioned, and for the ultraviolet absorbent, benzophenone-based or benzotriazole-based agents may be mentioned. Furthermore, within the scope of not impairing the effects of the present invention, the tacky layer may also contain a dye for color tone correction having the maximum absorption wavelength in the range of 300 to 800 nm, a neon light absorbing dye, a leveling agent, an antistatic agent or the like.

The tackifying agent that is used in the present invention is obtained by mixing under stirring the components described above at the proportions of, for example, 100 parts by weight of the acrylic acid-based copolymer, 0.1 to 20 parts by weight of the near-infrared absorbing dye, and 0 to 10 parts by weight of the other additives such as a crosslinking agent and an ultraviolet absorbent. However, upon considering performing a coating treatment on a transparent base, it is preferable to obtain a tackifying agent by dissolving or dispersing, for example, 100 parts by weight of the acrylic acid-based copolymer, 0.1 to 20 parts by weight of the near-infrared absorbing dye, and 0 to 10 parts by weight of the other additives such as a crosslinking agent and an ultraviolet absorbent in a solvent, to subject the tackifying agent to a filtration treatment or the like as necessary, and then to prepare as a coating liquid. In this case, it is preferable to adjust the content of the tackifying agent in the coating liquid to 10 to 30%, and preferably 15 to 20%, by weight.

The near-infrared absorbing film of the present invention can be produced by coating the aforementioned coating liquid on a transparent supporting film that will be described later, and drying the coating liquid. In regard to the tackifying agent layer containing a near-infrared absorbing dye and other additives, the tacky layer is coated so that the thickness after drying reaches usually 1 to 50 μm, and preferably 10 to 30 μm, and is fixed by drying at 80 to 140° C.

It is also possible to employ a method of providing tackifying agent layer containing a near-infrared absorbing dye and other additives on a peelable (releasable) film such as a polyethylene terephthalate film, in the same manner as described above, and subsequently bonding this tackifying agent layer to the surface opposite to the surface where a layer having the functions of a functional film that will be described later is provided, to thereby transfer the tackifying agent layer.

As for the solvent that is used upon preparing the coating liquid as described above, an aliphatic hydrocarbon such as n-hexane or n-heptane; an aromatic hydrocarbon such as toluene or xylene; a ketone such as acetone, methyl ethyl ketone, methyl isobutyl ketone or cyclopentanone; an alcohol such as methanol, ethanol or i-propyl alcohol; an ether such as tetrahydrofuran or ethylene glycol monomethyl ether, an ester such as ethyl acetate or butyl acetate; a halogenated aliphatic hydrocarbon such as chloroform, methylene chloride or dichloroethylene; or an amide such as N,N-dimethylformamide or N,N-dimethylacetamide, may be mentioned. These organic solvents may be used alone, or may be used as appropriate mixtures if necessary.

In regard to the coating of the coating liquid, a known coating method such as a flow coating method, a spray coating method, a wire bar coating method, a blade coating method, a gravure coating method, a gravure reverse coating method, a roller coating method, a slit die coating method, or a comma coater method, can be appropriately selected and employed.

The material of the transparent supporting film that is used as the transparent base in the present invention can be appropriately selected from materials such as, for example, a polyester such as polyethylene terephthalate (PET) or polybutylene terephthalate (PBT); a polycarbonate (PC); a triacetate; a polyacrylate; a polymethacrylate (PMMA); a polyolefin such as polyethylene or polypropylene; a polystyrene; a cellulose; a polyurethane; and a polyvinyl chloride, and used. Preferably, a PET, a PC or a PMMA is used.

As for the thickness of the supporting film, the range of 10 to 500 μm is preferable in view of good workability. The surface of the supporting film can also be subjected to a corona discharge treatment, a plasma treatment or a glow discharge treatment, or provided with a coating of an anchor coating agent, a primer or the like, so as to increase the adhesiveness to the coated film Furthermore, it is more preferable if the transparent supporting film itself is a film having a single function or a plurality of functions of for example, reflection reducing properties, antiglare/reflection reducing properties, antistatic properties, antifouling properties, electromagnetic wave shielding properties, color tone adjustment and the like, and reasonable production of optical filters is made possible.

The near-infrared absorbing film of the present invention can be used alone as an optical film, but in a preferred embodiment, one or more of films having optional functionalities, other than the near-infrared absorbing film of the present invention, is laminated, and the laminate is used as an optical filter. Here, examples of the films having optional functionalities include an antireflection film or antiglare film for preventing background reflections to the display unit, and also enhancing the contrast of displayed images; an electromagnetic wave shielding film for cutting the electromagnetic waves emitted from a display device such as a PDP; a film for cutting neon light; a film having a hard coat layer that imparts scratch resistance or an antifouling layer for preventing contamination at the outermost surface; a tacky or adhesive film for laminating each of these layers; and the like.

Next, examples of the functional films mentioned above will be described in the following, but the functional films are not intended to be limited to these.

The antireflection film is a film that reduces reflected light by interfering the surface-reflected light and the interface-reflected light. The antireflection film is, for example, a film provided with a low refractive index layer formed by coating a refractive index lowering agent, for example, magnesium fluoride or silica, together with a binder resin on the surface of a transparent supporting film such as PET; or a film in which a hard coat layer, for example, a high refractive index layer formed by coating a refractive index increasing agent such as titanium oxide, zinc oxide or zirconia, is provided between a transparent supporting film and a low refractive index layer, so that the reflected lights coming from the respective layers are controlled to negate each other, to thereby improve visibility. The antiglare/reflection reducing film is a film having visibility further improved by dispersing fine particles of for example, a polystyrene-based resin, an acrylic resin or the like, in the high refractive index layer or other layers of a reflection reducing film, so as to cause diffuse reflection of any light from an external source.

The electromagnetic wave shielding film includes a mesh type in which very fine wires of a metal such as copper are held in a transparent supporting film in a reticulate geometrical pattern, and a thin film type in which a very thin film of a metal is held in a transparent supporting film within the scope of maintaining visible light transmissibility. However, since the thin film type generally does not allow transmission of near-infrared rays by reflecting the rays, a near-infrared absorbing film is not necessary for the thin film type. Therefore, as the electromagnetic wave shielding film to be laminated on the near-infrared absorbing film of the present invention, a mesh type film can be used.

In PDP's, neon light having a wavelength of 550 to 620 nm, which originates from the Ne gas generated at the time of applying voltage, causes a decrease in the color purity of red light, and thus needs to be cut to some extent at the front of the display. A neon light absorbing film having a neon light absorbing compound held in a transparent supporting film, is used. Examples of the neon light absorbing compound include azaporphyrin-based, cyanine-based, squarylium-based, azomethine-based, xanthene-based and azo-based compounds, and the like.

A method of obtaining a layer capable of simultaneously absorbing near-infrared rays and neon light, by incorporating a compound having a neon light absorbing ability into the tackifying agent layer having a near-infrared absorbing ability, may also be employed.

The optical filter of the present invention is obtained by using the near-infrared absorbing film of the present invention as the minimum constituent element, and sequentially laminating the films having an electromagnetic wave shielding function, a reflection reducing function, and other functions, on the near-infrared absorbing film. The optical filter of the present invention may be bonded to a glass plate or a plastic plate in advance and then attached to the front of a PDP, or may also be directly bonded to the front of a PDP.

The near-infrared absorbing film of the present invention can be produced by a convenient production method, and has excellent stability over time of the near-infrared absorbing ability, as well as excellent adhesive capability to glass, PET film, polycarbonate or the like, which are used in the substrates of optical functional films. Furthermore, the optical filter obtainable by laminating other functional films on this near-infrared absorbing film, gives excellent near-infrared absorbing effects along with other functions, as an optical filter for PDP's.

### EXAMPLES

The present invention will be described in more detail by way of Examples, but the present invention is not intended to be limited to these. In the Examples, unless stated otherwise, the term “parts” refers to parts by weight, and the term “%” refers to percentage by weight.

### Reference Example 1

### Synthesis of Copolymer 1

64 parts of butyl acrylate, 32 parts of cyclohexyl acrylate and 4 parts of acrylic acid as monomers, and 100 parts of ethyl acetate as a solvent were introduced into a flask having a volume of 1 L and equipped with a stirrer, a condenser, a temperature sensor and a nitrogen inlet tube, and the mixture was stirred to dissolve. Nitrogen was introduced to adjust the oxygen concentration in the gas phase to 0.1% by volume or less, and then the solution was heated to 70° C. 0.020 parts of azobisisobutyronitrile as a polymerization initiator, dissolved in a small amount of ethyl acetate, was added to the flask, and the resulting mixture was polymerized under heating for 7 hours while the temperature was maintained at 70° C. Thereby, a copolymer 1 of butyl acrylate, cyclohexyl acrylate and acrylic acid was obtained. Methyl ethyl ketone was added to this copolymer, to dissolve the copolymer to a polymer concentration of 25%, and thereby a resin solution was obtained. The weight average molecular weight measured by gel permeation chromatography (GPC) (standard: polystyrene) was 1,800,000.

### Reference Example 2

### Synthesis of Copolymer 2

A copolymer 2 of butyl acrylate, isobornyl acrylate and acrylic acid was obtained by the same method as that used in Reference Example 1, except that 72 parts of butyl acrylate, 24 parts of isobornyl acrylate and 4 parts of acrylic acid were used as the monomers. Methyl ethyl ketone was added to this copolymer to dissolve the copolymer to a polymer concentration of 25%, and thereby a resin solution was obtained. The weight average molecular weight measured by GPC was 1,100,000.

### Reference Example 3

### Synthesis of Copolymer 3

A copolymer 3 of butyl acrylate, 4-t-butylcyclohexyl acrylate and acrylic acid was obtained by the same method as that used in Reference Example 1, except that 64 parts of butyl acrylate, 32 parts of 4-t-butylcyclohexyl acrylate and 4 parts of acrylic acid were used as the monomers. Methyl ethyl ketone was added to this copolymer to dissolve the copolymer to a polymer concentration of 25%, and thereby a resin solution was obtained. The weight average molecular weight measured by GPC was 1,500,000.

### Reference Example 4

### Synthesis of Copolymer 4 for Comparison

A copolymer 4 for comparison of butyl acrylate and acrylic acid was obtained by the same method as that used in Reference Example 1, except that 96 parts of butyl acrylate and 4 parts of acrylic acid were used as the monomers. Methyl ethyl ketone was added to this copolymer to dissolve the copolymer to a polymer concentration of 25% (by weight), and thereby a resin solution was obtained. The weight average molecular weight measured by GPC was 1,700,000.

### Example 1

### Production of Near-Infrared Absorbing Film

A coating liquid prepared by mixing and dissolving the materials indicated in Table 1 to a uniform state, was coated on a peelable PET film (trade name: PET•3811, manufactured by Lintech International LLC), with a comma coater at a coating rate of 0.8 m/min, so that the thickness of the tackifying agent layer would be 18 μm at a drying temperature of 110° C., and thus a tackifying agent layer was formed. The PET film was bonded to the surface opposite to the reflection reducing surface of a reflection reducing film (trade name: KAYACOAT ARS-D511, manufactured by Nippon Kayaku Co., Ltd.), with this tackifying agent layer interposed between the films. Thus, a near-infrared absorbing film of the present invention having reflection reducing properties was obtained.

TABLE 1

| Material | Amount used |
|---|---|
| Tackifying agent (copolymer 1 of Reference Example 1) | 120.0 parts |
| Near-infrared absorbing dye (diimmonium-based dye; | 1.5 parts |
| in the formula (1), R₁ to R₈ are mixtures of | |
| i-butyl and n-propyl, and X⁻ is a | |
| tris(trifluoromethanesulfonyl)methidate ion) | |
| Ultraviolet absorbent (trade name: TINUVIN 109, | 1.0 parts |
| manufactured by Ciba Geigy, Ltd.) | |
| Crosslinking agent (trade name: M12ATY, | 0.37 parts |
| manufactured by Nippon Kayaku Co., Ltd.) | |
| Crosslinking agent (trade name: L45EY, | 0.45 parts |
| manufactured by Nippon Kayaku Co., Ltd.) | |
| Methyl ethyl ketone | 76.7 parts |

(Remarks)
Trade name TINUVIN 109; benzotriazole-based compound
Trade name M12ATY; metal chelate compound
Trade name L45EY; isocyanate compound

(Production of Optical Filter for PDP)

The protective film of an electromagnetic wave shielding film (trade name: ES-1534U (HCD-42-02), manufactured by Hitachi Chemical Co., Ltd.) having a protective film and a tacky layer, was peeled off, and the peelable PET film of the infrared absorbing film obtained in Example 1 was peeled off. The two films were bonded, with the tacky layer interposed therebetween, and thus an optical filter for PDP's was obtained. This optical filter sufficiently exhibited the performance required from a PDP filter in all occasions, regardless of whether the filter was directly bonded to the front of a PDP module, or whether the filter was bonded to a transparent plate such as a glass plate, and the plate was attached to the front of the module.

### Example 2

### Production of Near-Infrared Absorbing Film

A coating liquid prepared by mixing and dissolving the materials indicated in Table 2 to a uniform state, was coated on a peelable PET film (trade name: PET-3811, manufactured by Lintech International LLC), with a comma coater at a coating rate of 0.8 m/min, so that the thickness of the tackifying agent layer would be 18 μm at a drying temperature of 110° C., and thus a tackifying agent layer was formed. The PET film was bonded to the surface opposite to the reflection reducing surface of a reflection reducing film (trade name: KAYACOAT ARS-D511, manufactured by Nippon Kayaku Co., Ltd.), with this tackifying agent layer interposed between the films. Thus, a near-infrared absorbing film of the present invention having reflection reducing properties was obtained.

TABLE 2

| Material | Amount used |
|---|---|
| Tackifying agent (copolymer 2 of Reference Example 2) | 120.0 parts |
| Near-infrared absorbing dye (diimmonium-based dye; | 1.3 parts |
| in the formula (1), R₁ to R₈ are mixtures of | |
| i-butyl and n-propyl, and X⁻ is a | |
| tris(trifluoromethanesulfonyl)methidate ion) | |
| Ultraviolet absorbent (trade name: TINUVIN 109, | 1.0 parts |
| manufactured by Ciba Geigy Ltd.) | |
| Crosslinking agent (trade name: M12ATY, | 0.37 parts |
| manufactured by Nippon Kayaku Co., Ltd.) | |
| Crosslinking agent (trade name: L45EY, | 0.45 parts |
| manufactured by Nippon Kayaku Co., Ltd.) | |
| Methyl ethyl ketone | 76.7 parts |

### Example 3

### Production of Near-Infrared Absorbing Film

A coating liquid prepared by mixing and dissolving the materials indicated in Table 3 to a uniform state, was coated on a peelable PET film (trade name: PET •3811, manufactured by Lintech International LLC), with a comma coater at a coating rate of 0.8 m/min, so that the thickness of the tackifying agent layer would be 18 μm at a drying temperature of 110° C., and thus a tackifying agent layer was formed. The PET film was bonded to the surface opposite to the reflection reducing surface of a reflection reducing film (trade name: KAYACOAT ARS-D511, manufactured by Nippon Kayaku Co., Ltd.), with this tackifying agent layer interposed between the films. Thus, a near-infrared absorbing film of the present invention having reflection reducing properties was obtained.

TABLE 3

| Material | Amount used |
|---|---|
| Tackifying agent (copolymer 3 of Reference Example 3) | 120.0 parts |
| Near-infrared absorbing dye (diimmonium dye; | 1.3 parts |
| in the formula (1), R₁ to R₈ are mixtures of i-butyl | |
| and n-propyl, and X⁻ is a | |
| tris(trifluoromethanesulfonyl)methidate ion) | |
| Ultraviolet absorbent (trade name: TINUVIN 109, | 1.0 parts |
| manufactured by Ciba Geigy, Ltd.) | |
| Crosslinking agent (trade name: M12ATY, | 0.37 parts |
| manufactured by Nippon Kayaku Co., Ltd.) | |
| Crosslinking agent (trade name: L45EY, | 0.45 parts |
| manufactured by Nippon Kayaku Co., Ltd.) | |
| Methyl ethyl ketone | 76.7 parts |

(Production of Optical Filter for PDP)

The peelable PET film of the infrared absorbing film was peeled off and the infrared absorbing film was bonded to the surface opposite to the protective film of an electromagnetic wave shielding film (trade name: ES-1534U (HCD-42-2), manufactured by Hitachi Chemical Co., Ltd.) having a protective film and a tacky layer, with the tacky layer interposed between the two films. Thus, an optical filter for PDP's was obtained. This optical filter sufficiently exhibited the performance required from a PDP filter in all occasions, regardless of whether the protective film was peeled off, and the filter was directly bonded to the front of a PDP module, or whether the filter was bonded to a transparent plate such as a glass plate, and the plate was attached to the front of the module.

### Comparative Example 1

### Production of Near-Infrared Absorbing Film

A near-infrared absorbing film having reflection reducing properties was obtained by the same method as that used in Example 1, except that the tackifying agent indicated in Table 1 was replaced with the copolymer 4 for comparison of Reference Example 4.

Performance Test

Testing Method

In regard to the near-infrared absorbing film of Examples 1, 2 and 3, and Comparative Example 1, changes in the luminous transmittances (Y), the transmittance at a wavelength of 950 nm in the near-infrared region, and the haze were measured by making measurements immediately after the production (0 hour), and after performing tests for heat resistance and moist-heat resistance (500 hours). The films were stored in a constant temperature and constant humidity chamber for 500 hours, at 80° C. for the heat resistance test, and at 60° C. and a relative humidity of 90% for the moist-heat resistance test. The results for the durability tests are presented in Table 4 and Table 5.

In each of the tables, a spectrophotometer (trade name: UV-3150, manufactured by Shimadzu Corporation.) was used for the measurement of the luminous transmittance (Y) and the transmittance at a wavelength of 950 nm in the near-infrared region, and a haze meter (trade name: TC-HIIIDPK, manufactured by Tokyo Denshoku Co., Ltd.) was used for the measurement of haze.

TABLE 4
Results for heat resistance test

| | | | | | Comparative |
|---|---|---|---|---|---|
| Testing time (hours) | | Example 1 | Example 2 | Example 3 | Example 1 |
| Luminous | 0 | 73.9 | 75.2 | 73.3 | 72.6 |
| transmittance | 500 | 73.8 | 75.5 | 74.1 | 72.5 |
| Y (%) | | | | | |
| Transmittance | 0 | 3.05 | 3.57 | 3.65 | 5.78 |
| at wavelength | 500 | 2.77 | 3.17 | 3.73 | 10.94 |
| of 950 nm | | | | | |
| (%) | | | | | |
| Haze (%) | 0 | 1.6 | 1.9 | 1.5 | 2.1 |
| | 500 | 2.5 | 2.9 | 2.1 | 4.1 |

TABLE 5
Results for moist-heat resistance test

| | | | | | Comparative |
|---|---|---|---|---|---|
| Testing time (hours) | | Example 1 | Example 2 | Example 3 | Example 1 |
| Luminous | 0 | 73.7 | 75.0 | 73.7 | 72.1 |
| transmittance | 500 | 73.7 | 75.3 | 73.9 | 72.3 |
| Y (%) | | | | | |
| Transmittance | 0 | 3.59 | 4.03 | 3.71 | 5.90 |
| at wavelength | 500 | 4.00 | 5.00 | 3.10 | 11.30 |
| of 950 nm | | | | | |
| (%) | | | | | |
| Haze (%) | 0 | 1.6 | 1.9 | 1.6 | 2.1 |
| | 500 | 2.1 | 2.6 | 1.8 | 4.9 |

Discussion of Results

As can be seen from the results of Table 4 and Table 5, the near-infrared absorbing films of Examples 1, 2 and 3 underwent less changes in the transmittances and the haze after the durability tests, than the near-infrared absorbing film of Comparative Example 1. In particular, the changes in the haze and the transmittance at a wavelength of 950 nm were smaller, and the durability was satisfactory.

1. A near-infrared absorbing film comprising a transparent base, and provided on one side of the base, a tacky layer formed from a tackifying agent containing a near-infrared absorbing dye and a copolymer having a (C5-C10) cycloalkyl ester of (meth)acrylic acid as a constituent monomer.

2. The near-infrared absorbing film according to claim 1, wherein the copolymer is a copolymer having a (C5-C10) cycloalkyl ester of (meth)acrylic acid, a (C3-C10) alkyl ester of (meth)acrylic acid, and an unsaturated polybasic acid or a (meth)acrylic acid-based monomer having a functional group, as constituent monomers.

3. The near-infrared absorbing film according to claim 1 or 2, wherein the (C5-C10) cycloalkyl ester of (meth)acrylic acid is at least one compound selected from the group consisting of cyclopentyl acrylate, cyclohexyl acrylate, methyl-substituted cyclohexyl acrylate, t-butyl-substituted cyclohexyl acrylate, isobornyl acrylate, and decahydro-2-naphthyl acrylate.

4. The near-infrared absorbing film according to any one of claims 1 to 3, wherein the near-infrared absorbing dye is a diimmonium-based dye represented by the following formula (1): 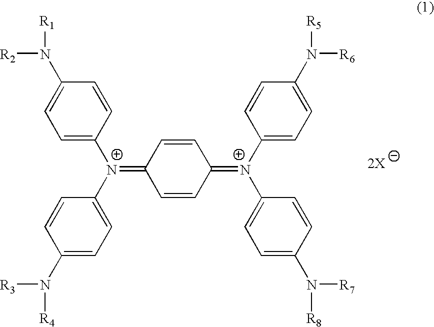
wherein R₁ to R₈ each independently represent a hydrogen atom or an aliphatic hydrocarbon residue which may have a substituent, and X represents a monovalent anion.

5. The near-infrared absorbing film according to any one of claims 1 to 4, wherein the tackifying agent forming the tacky layer contains a crosslinking agent.

6. An optical filter for plasma display panels, comprising the near-infrared absorbing film according to any one of claims 1 to 5, and a film having an electromagnetic wave shielding function and/or a film having a reflection reducing function, as constituent elements.
